(19) United States
(12) Patent Application Publication
(10) Pub. No.: US 2008/0037405 A1
(43) Pub. Date: Feb. 14, 2008

(54) DISC RECORDING AND REPRODUCING APPARATUS

(76) Inventors: Yuji Fujita, Yokohama (JP); Naoko Fujita, Yokohama (JP); Shohei Fujita, Yokohama (JP); Naoko Fujita, Yokohama (JP); Yasuo Amano, Yokohama (JP); Hiroyuki Minemura, Kokubunji (JP); Akemi Hirotsune, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/751,090

(22) Filed: May 21, 2007

(30) Foreign Application Priority Data
May 23, 2006 (JP) 2006-142765

(51) Int. Cl. G11B 3/70

(52) U.S. Cl. 369/283

(57) ABSTRACT

The present invention achieves a disc recording and reproducing apparatus capable of using an inexpensive disc by loosening the tolerance of track offset of each layer of a multilayer optical disc, and capable of ensuring the reliability of the disc by relieving external forces exerted on the disc at the loading or unloading of the disc. A disc holder that rotates while holding a multilayer optical disc is configured of a non-moving part fixed to a rotating shaft, and a moving part. Actuators are used to drive the moving part having the optical disc fixed thereto relative to the non-moving part, thereby correcting the offset of a recording layer with respect to the rotating shaft.

### CLAIM OF PRIORITY

The present application claims priority from Japanese application JP 2006-142765 filed on May 23, 2006, the content of which is hereby incorporated by reference into this application.

### BACKGROUND OF THE INVENTION

1. Field of the Invention

The present invention relates to an optical disc recording and reproducing apparatus and more particularly to a disc recording and reproducing apparatus suitable for a multilayer optical disc.

2. Description of the Related Art

What is known as track offset is generally encountered in optical disc recording and reproduction. Specifically, a track center of an optical disc is offset from a center of rotation of a rotor that holds the optical disc. A recording and reproducing apparatus has to perform tracking control in order to perform normal recording and reproduction even at the occurrence of a track offset.

An optical disc recording and reproducing apparatus is shown in FIG. 14. The optical disc recording and reproducing apparatus includes a motor 202 that rotates an optical disc 201, and an optical pickup 205 containing a tracking actuator 204 that drives an objective lens 203 across tracks of the optical disc, that is, the lens 203 is driven radially. Circuitry for controlling these devices is configured of a tracking-error signal generator circuit 206 that generates a tracking-error signal based on an output signal from a photodetector of the optical pickup 205, a tracking-actuator control circuit 207 that generates control information required for the tracking actuator 204, and a tracking-actuator drive circuit 208 that drives the tracking actuator 204.

Description will be given below with regard to a tracking control method for the recording and reproducing apparatus. While being rotated by the motor 202, the optical disc 201 is radiated with laser light. The tracking-error signal generator circuit 206 generates a tracking-error signal based on an output from the photodetector of the optical pickup 205. Based on the tracking-error signal, the tracking-actuator control circuit 207 generates information required for tracking actuator control, such as amplitude, frequency or phase characteristics. By using the information, the tracking-actuator drive circuit 208 drives the tracking actuator 204 so that the objective lens 203 is kept on the tracks of the optical disc.

[patent document 1] Japanese Patent Application Laid-open Publication No. 2004-145983.

### SUMMARY OF THE INVENTION

As for a multilayer optical disc, an offset of a track center occurs for each layer in a manufacturing process for the multilayer optical disc. FIG. 15 shows an example of the manufacturing process for the multilayer optical disc. A base 701 has a center pin 705, which projects at the center of the base 701. A disc substrate 702 has on its top an irregular pattern, which is formed by, for example, injection molding and is formed of tracking grooves and information pits. A center hole 706 in the center of the disc substrate 702 is fitted onto the center pin 705, and thereby the disc substrate 702 is set on top of the base 701. Then, the surface of the disc substrate 702 is coated with an interlayer 703 made of an ultraviolet cure resin or the like. Then, a transfer substrate 704 is pressed onto the interlayer 703 in an uncured state. The transfer substrate 704 has an irregular pattern formed of grooves and information recording pits required for a second recording layer. The irregular pattern is formed on the surface of the interlayer 703 by pressing the transfer substrate 704 onto the surface of the interlayer 703, then the resin of the interlayer 703 is cured, and subsequently, the transfer substrate 704 is removed, whereby the second recording layer is formed on the surface of the disc substrate 702.

With the above method, the respective inner diameters of the center holes 706 and 707 of the disc substrate 702 and the transfer substrate 704 must be, in the order of a few tens of micrometers, larger than the outside diameter of the center pin 705 so that the center holes 706 and 707 can smoothly fit onto the center pin 705. Thus, the center of the transfer substrate 704 is offset an amount d with respect to the center of the center pin 705.

In the case of the multilayer optical disc, as mentioned above, the offset d of the transfer substrate is added as the amount of track offset, and it is therefore necessary to enlarge the driving range of the tracking actuator 204 and to also increase a tracking speed. However, the limit to heat produced by the actuator leads to an upper limit to applicable power, also resulting in a limit to trackability of the actuator. As for the multilayer optical disc, it is therefore required that tolerances of, for example, 100 μm or less be specified as the tolerance of the amount of offset of the track center for each layer. However, an increase in the number of layers makes it difficult to maintain level-to-level alignment accuracy within the tolerance, thus causing a reduction in yields, resulting in a rise in manufacturing costs for the optical disc.

In the future, it will be further necessary to increase the accuracy of position of the actuator to deal with an increase in a recording density of the optical disc. The upper limit to the power applicable to the actuator, due to the limit to heat produced by the actuator, as mentioned above, makes it more difficult for the actuator to achieve both the required accuracy of position and the required driving range. Thus, a high-density optical disc requires a further reduction in the amount of offset of the track center and hence causes a further rise in manufacturing costs for the disc.

Moreover, the multilayer optical disc includes a plurality of thin films that are vulnerable to external forces and thus prone to peel off, while the number of films is likely to grow larger in the future. There is also an increase in the sum of the thicknesses of the thin films, and therefore, internal stress in a topmost layer also becomes greater than that of a conventional optical disc. Due to these factors, a recording apparatus in which an optical disc is subjected to external force when being handled can possibly reduce the reliability of the multilayer optical disc. A low-profile optical disc drive developed for use in a notebook computer, in particular, uses a disc holding mechanism formed of a plurality of nails and a spring that forces the nails outwardly, so that the disc can be held at one side. When the disc is loaded on a hub or unloaded from the hub, a problem may possibly occur where the nails get caught on the disc, the disc incurs external forces equal to or greater than its yield strength, so that the recording film is peeled off.

An object of the present invention is to achieve a disc reproducing apparatus capable of using an inexpensive optical disc by loosening the tolerance of track offset of each layer of the multilayer optical disc. Another object of the present invention is to achieve a low-profile disc recording and reproducing apparatus capable of ensuring the reliability of the multilayer optical disc by relieving external forces exerted on the disc at the loading or unloading of the disc.

A recording and reproducing apparatus of the present invention includes: a rotor including a disc holder that holds an optical disc having a plurality of recording layers; a driver that rotatably drives the rotor around a rotating shaft; and an optical head that radiates a desired recording layer of the optical disc held by the disc holder with recording light and/or reproducing light, in which the disc holder includes an offset correction unit that corrects the held position of the held optical disc with respect to the rotating shaft. When an electromagnetic inductor for supplying power in a non-contacting manner from a stationary part to the rotor is disposed between the rotor and the stationary part, the power supplied to the rotor can be used to drive the unit for correcting the track offset of the optical disc. By adopting the approach of using the offset correction unit for correcting the amount of relative offset between the layers of the multilayer optical disc, recording and reproduction are made possible by use of an inexpensive optical disc whose level-to-level alignment accuracy does not satisfy tolerance.

A magnetic sensor and a magnetic material may be disposed between the rotor and the stationary part in order to detect an angle of rotation of the rotor. Rotor rotation angle information is read from electromotive force that is outputted when the magnetic sensor moves closer to the magnetic material. At the same time, the amplitude and phase of the amount of offset that is optical disc offset information are obtained by radiating the optical disc with a laser and detecting reflected components. The direction of offset of the optical disc with respect to the rotor can be determined by bringing the rotor rotation angle information into correspondence with the optical disc offset information. The direction of driving movement of the offset correction unit can be promptly determined in accordance with the offset information. This enables a reduction in learning time for offset correction, as compared to a correction method by random driving of the offset correction unit and feedback therefrom.

Moreover, a manufacturing process for the multilayer optical disc may include recording, on the disc, offset information on each recording layer measured for each disc. When the disc is loaded on the recording and reproducing apparatus for the first time, offset correction is performed only once, by measuring the amount of offset with a laser. For any other layer, relative offset information recorded on the disc can be used for offset adjustment. This eliminates the need for measuring the amount of offset for each layer, and hence enables reducing time for offset correction at the time of change from one to another of the layers. The offset information on each recording layer may be recorded on a predetermined specified recording layer. In this case, when the optical disc is manufactured so that the specified recording layer alone satisfies the tolerance of the amount of offset, the actuators can perform tracking on the specified layer without the need for offset correction. Since relative offset information on other layers is recorded on the specified layer, the reading of this information makes it possible to quickly determine the amount of driving movement of the offset correction unit and hence complete offset correction in a short time. The offset information on each recording layer may be recorded in a burst cutting area of the optical disc. The information in the burst cutting area can be read without the need for disc offset correction. Thus, reading this information makes it possible to promptly determine the amount of driving movement of the offset correction unit and hence complete offset correction in a short time.

Moreover, a ball balancer formed of a plurality of balls may be contained in the rotor. This can reduce the amount of offset of the offset-corrected disc's center with respect to the center of the rotor, and hence relieves vibrating forces acting on the rotating shaft during rotation of the disc. This is effective in reducing motor power consumption, and also improves long-term reliability of a disc unit.

Moreover, a disc fixing unit for fixing the optical disc to the rotor may be provided and be driven by the power supplied to the rotor. Since an electromagnetic actuator, an electrostatic actuator, or the like can be used as the disc fixing unit, nails can be driven to a position where the nails do not get caught on the disc at the time of loading or unloading of the disc. This enables reducing external forces applied to the multilayer optical disc and therefore providing a highly reliable disc recording and reproducing apparatus. As the disc fixing unit, a magnetic material may be provided at the center of the disc, and an electromagnetic force generator may be provided in the rotor. By controlling the amount and direction of a current to the electromagnetic force generator, the electromagnetic force generator can generate any given holding force including forces for attracting and repelling the disc. This enables reducing external forces applied to the multilayer optical disc at the time of loading or unloading of the disc, thus providing a highly reliable disc recording and reproducing apparatus. Further, the above holding force acts only on the inside of the rotor and does not act on a contact surface between the shaft and the bearing. This keeps power consumption from increasing during rotation of the disc, and also maintains long-term reliability of the bearing.

Moreover, the inner diameter of the high-density, high-standard disc may be smaller than the inner diameter of the low-density, low-standard disc. Thus, the smaller inner diameter inhibits the insertion of the high-standard disc into a drive for the low-standard disc, and therefore enables preventing erroneous operation.

Moreover, a unit for evaluating the inner diameter of the loaded disc by measuring a distance traveled by the disc fixing unit may be provided. By associating the inner diameter of the disc and the recording density standard, the drive in itself can determine the standard of the loaded disc by evaluating the inner diameter of the loaded disc. This eliminates the need for laser emission or radiation to determine the standard, thus enabling quicker disc recording and reproduction.

Moreover, a motor configured of a stator core and a rotor magnet may be disposed in the outer periphery surrounding the electromagnetic inductor. As a result, the electromagnetic inductor and the motor are not stacked on top of each other in the thickness direction of the drive. This makes it possible to achieve a lower-profile disc recording and reproducing apparatus than hitherto. A notebook computer, the market of which will be expected to expand in the future, can be equipped with the above-described multilayer optical disc drive.

The present invention enables the use of an inexpensive optical disc because of being capable of loosening the tolerance of track offset of each layer of the multilayer optical disc. Moreover, the present invention can achieve a disc recording and reproducing apparatus capable of ensuring the reliability of the multilayer optical disc, because of relieving external forces exerted on the disc at the loading or unloading of the disc.

### BRIEF DESCRIPTION OF THE DRAWINGS

FIG. 1 is a cross-sectional view of a disc recording and reproducing apparatus according to a first embodiment of the present invention.

FIG. 2 is a cross-sectional view of a disc holder and its surroundings according to the first embodiment of the present invention.

FIG. 3 is a plan view of the disc holder according to the first embodiment of the present invention, as seen from the direction of a rotating shaft.

FIG. 4 is a cross-sectional view of a disc recording and reproducing apparatus according to a second embodiment of the present invention.

FIG. 5 is a plan view of a multilayer optical disc according to the second embodiment of the present invention, as seen from the direction of the rotating shaft.

FIGS. 6A and 6B are diagrams showing a recording region for offset information on the multilayer optical disc.

FIGS. 7A and 7B are diagrams of a burst cutting area and its read signal wave, respectively, of a multilayer optical disc according to a third embodiment of the present invention.

FIG. 8 is a cross-sectional view of a disc recording and reproducing apparatus according to a fourth embodiment of the present invention.

FIG. 9 is a cross-sectional view of the disc holder and its surroundings according to a fifth embodiment of the present invention.

FIG. 10 is a cross-sectional view of the disc holder and its surroundings according to a sixth embodiment of the present invention.

FIGS. 11A and 11B are cross-sectional views of the holder for holding optical discs adapted for different standards for recording densities and its surroundings according to a seventh embodiment of the present invention.

FIG. 12 is a cross-sectional view of the disc holder and its surroundings according to an eighth embodiment of the present invention.

FIG. 13 is a cross-sectional view of an information recording apparatus according to a ninth embodiment of the present invention.

FIG. 14 is a block diagram showing a tracking control method for a conventional disc recording and reproducing apparatus.

FIG. 15 is a cross-sectional view of assistance in explaining a manufacturing process for the multilayer optical disc.

FIG. 16 is a flowchart showing a procedure for offset adjustment.

FIG. 17 is a block diagram of the configuration of an information recording apparatus using offset information measured at each time of loading of the optical disc.

### DESCRIPTION OF THE PREFERRED EMBODIMENTS

Description will be given below with regard to embodiments of the present invention with reference to the accompanying drawings.

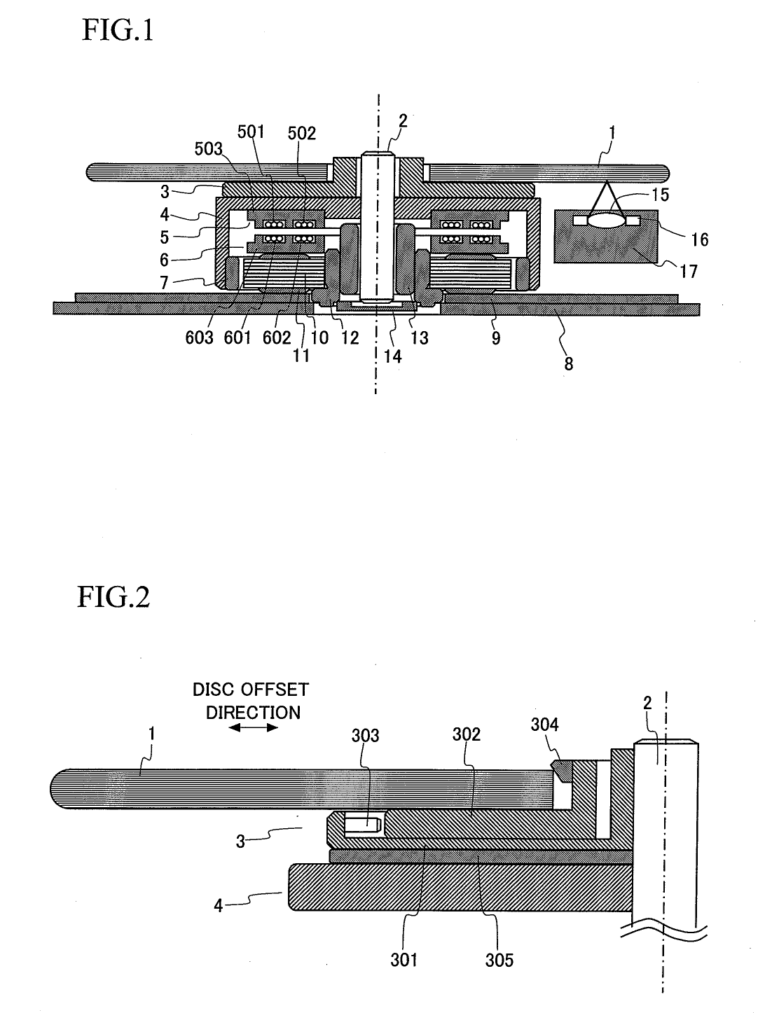

FIG. 1 is a cross-sectional view taken through a disc rotating shaft, of a disc recording and reproducing apparatus according to a first embodiment of the present invention.

In FIG. 1, a multilayer optical disc 1 is fixed to a disc holder 3, and the disc holder 3 is fixed to a hub 4. The hub 4 is fixed to a rotating shaft 2, and the multilayer optical disc 1 rotates around the rotating shaft 2 in conjunction with the disc holder 3 and the hub 4. A ring-shaped rotor magnet 7 is fixed to a bottommost portion of the hub 4. Also, a circuit board 9, a stator core 10 and winding 11 are disposed on top of a base 8. The supply of a predetermined drive current to the winding 11 produces a torque between the stator core 10 and the rotor magnet 7, and thereby enables the multilayer optical disc 1 to rotate at a few thousands of revolutions per minute in conjunction with the hub 4 and the disc holder 3.

A stator core fixing ring 12 and a bearing 13 are disposed in the inner periphery of the stator core 10. A fluid dynamic pressure bearing is charged to fill in between the bearing 13 and the rotating shaft 2, and a cap 14 for preventing leakage of the fluid dynamic pressure bearing is attached on the underside of the rotating shaft 2. Although in the first embodiment a fluid bearing structure is given as an example, other structures, such as a bearing structure using a ball bearing, may be used.

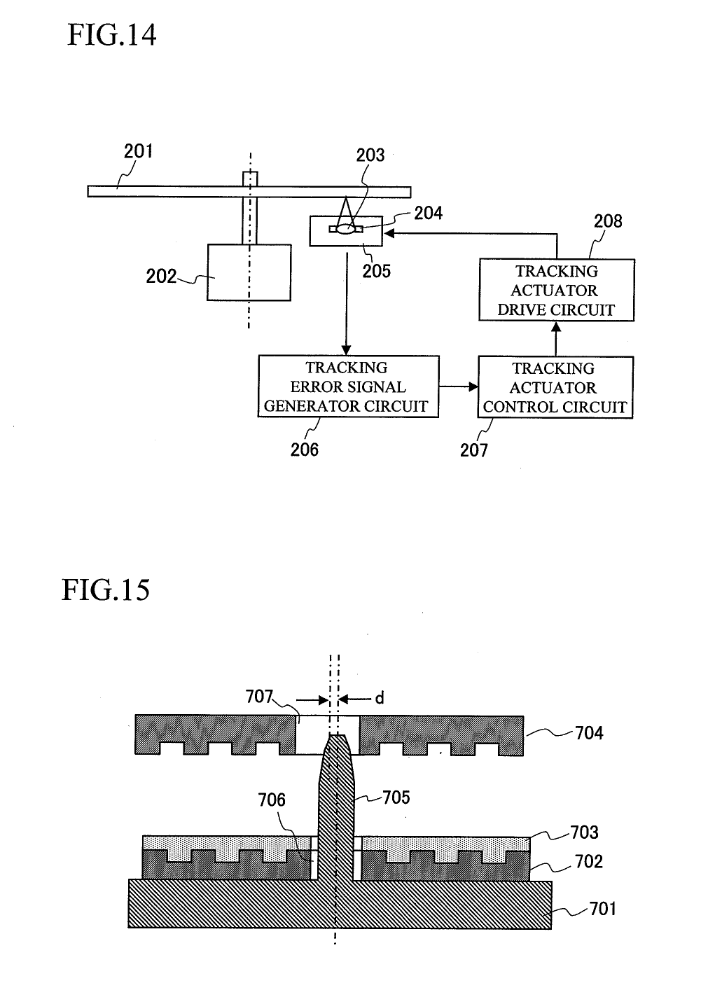

An optical pickup 17 including an objective lens 15 and a tracking actuator 16 is faced to the underside of the multilayer optical disc 1. As has been described in connection with FIG. 14, while rotating the multilayer optical disc 1, laser light from the optical pickup 17 is radiated at a desired recording layer of the multilayer optical disc 1. A photodetector of the optical pickup 17 receives reflected components of the laser light. From these signals, control information for the tracking actuator 16 is generated, and the tracking actuator 16 is driven so that the objective lens 15 maintains a position suitable for recording and reproduction. Moreover, a focus error signal is generated from a reproduction signal, and the objective lens 15 is driven in a focus direction by an actuator (not shown) so that its focal point coincides with the desired recording layer of the multilayer optical disc 1.

A rotor-side electromagnetic inductor 5 for supplying power and a control signal to the disc holder 3 is disposed on the underside of the hub 4. The rotor-side electromagnetic inductor 5 is configured of a rotor-side power receiving coil 501, a rotor-side control signal receiving coil 502, and a rotor-side core 503.

A stator-side electromagnetic inductor 6 for supplying power and a control signal to the rotor-side electromagnetic inductor 5 is disposed on top of the stator core 10 and the winding 11. The stator-side electromagnetic inductor 6 is configured of a stator-side power transmitting coil 601, a stator-side control signal transmitting coil 602, and a stator-side core 603.

The power receiving coil 501 and the power transmitting coil 601 are configured as winding concentrically with respect to the rotating shaft 2, and these coils in a pair face each other as spaced an infinitesimal distance of the order of approximately ten micrometers away from each other. When an alternating current of approximately 100 kHz is supplied to the power transmitting coil 601 by a power supply circuit in the circuit board 9 disposed on top of the base 8, an alternating-current flux is generated around the power transmitting coil 601. The core 603 and the core 503 are made of a soft magnetic material permeable to the alternating-current flux, such as ferrite powder containing zinc, manganese, or the like. The alternating-current flux passes through the core 603 and partially enters the core 503 facing the core 603. A change in magnetic flux within the core 503 allows an induced electromotive force to develop in the power receiving coil 501. An electrode across the power receiving coil 501 is connected via a flexible printed board or the like to a drive circuit for the disc holder 3, and the alternating-current induced electromotive force from the coil 501 is converted through a smoothing circuit in the drive circuit into a direct current, which in turn is supplied as a drive current for the disc holder 3.

Since the power receiving and transmitting coils 501 and 601, and the cores 503 and 603 are configured concentrically with respect to the rotating shaft 2, even a change in the speed of rotation of the hub 4, in principle, does not cause a change in the magnetic circuit. Thus, the amplitude and frequency of the alternating-current flux passing through the core 503 are held constant regardless of the speed of rotation of the hub 4. This enables to ensure a stable supply of power to the disc holder 3.

The rotor-side control signal receiving coil 502 and the stator-side control signal transmitting coil 602 likewise face each other as spaced an infinitesimal distance of the order of approximately ten micrometers away from each other. When an alternating current is supplied to the signal transmitting coil 602 by a control circuit disposed in the circuit board 9, an alternating-current flux is generated within the core 603 and the core 503 in the same manner as previously described, and an induced electromotive force develops in the signal receiving coil 502. An electrode across the signal receiving coil 502 is connected via a flexible printed board or the like to a drive circuit for the disc holder 3, and the induced electromotive force from the coil 502 is amplified and converted within the drive circuit and in turn is used as a control current for the disc holder 3.

FIG. 2 is a cross-sectional view taken through the disc rotating shaft 2, of the multilayer optical disc 1 and the disc holder 3 with its surroundings, shown in FIG. 1.

The disc holder 3 is formed of a non-moving part 301, a moving part 302, a plurality of actuators 303 that move the moving part 302 in a disc offset direction, a disc retainer 304 for fixing the multilayer optical disc 1 on the surface of the moving part 302, and a drive circuit 305 for driving the actuators 303. The non-moving part 301 and the drive circuit 305 are fixedly bonded to the hub 4, and the moving part 302 and the multilayer optical disc 1 are held on top of the non-moving part 301, to be movable in the disc offset direction.

The actuators 303 are disposed in a plurality of places in the periphery of the non-moving part 301, and tips of the actuators 303 expand and contract to move the moving part 302 and the multilayer optical disc 1 in the disc offset direction. The actuators 303 are those capable of controlling the amount of expansion and contraction depending on an applied voltage or current, and are configured of electromagnetic actuators, electrostatic actuators, or the like. The amount of expansion and contraction of the actuators 303 is determined by drive power generated by the drive circuit 305, in reference to control information received by the signal receiving coil 502.

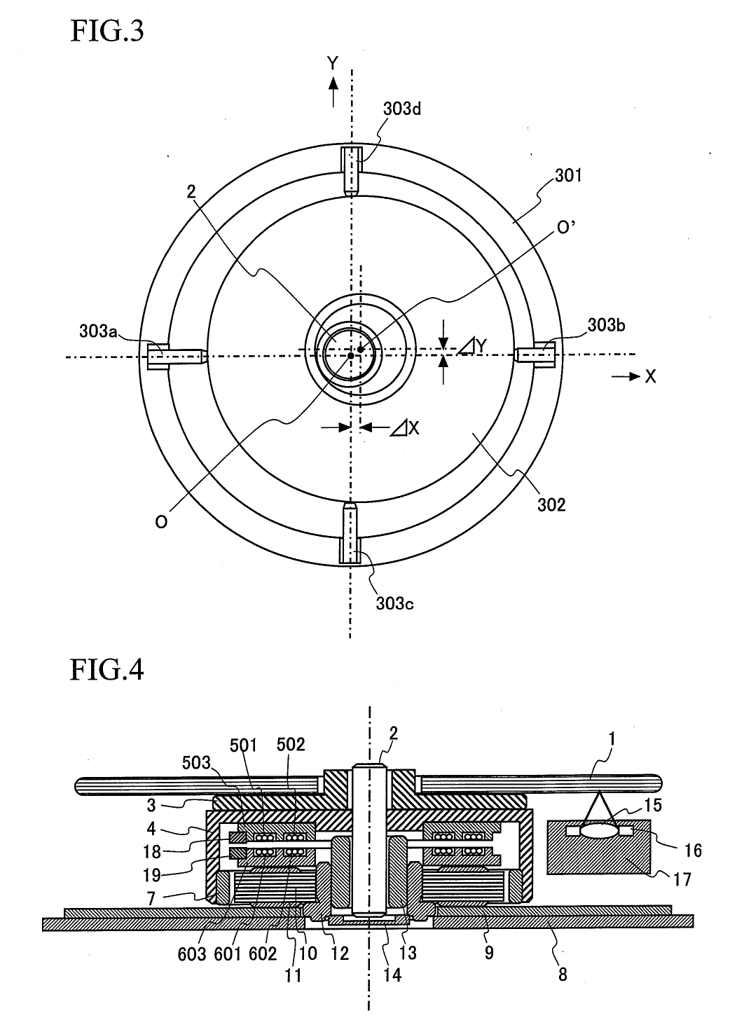

FIG. 3 is a plan view of the holder 3 shown in FIG. 2, as seen from the direction of the rotating shaft 2. The multilayer optical disc 1, the disc retainer 304 and the hub 4 are omitted from FIG. 3 so that the moving part 302 can be readily seen.

The non-moving part 301 is fixedly bonded to the hub 4 so that the center of rotation of the non-moving part 301 coincides with a center O of rotation of the rotating shaft 2. Actuators 303a and 303b, and actuators 303c and 303d are disposed on the X axis and the Y axis, respectively, both axes passing through the center O of the non-moving part 301. When the actuators 303a and 303b perform expansion and contraction, respectively, in the direction of the X axis by the drive power generated by the drive circuit 305, the moving part 302 travels ΔX in the direction of the X axis. When the actuators 303c and 303d likewise perform expansion and contraction, respectively, in the direction of the Y axis, the moving part 302 travels ΔY in the direction of the Y axis. As a result, the moving part 302 moves in the direction of a vector OO′, and the multilayer optical disc 1 also moves in the direction of the vector OO′.

Offset information on the multilayer optical disc 1 is obtained by radiating the optical disc with a laser while the optical disc makes one rotation, and then by detecting reflected components. The information is transmitted to the drive circuit 305 shown in FIG. 2 through electromagnetic coupling between the coils 602 and 502 shown in FIG. 1. The drive circuit 305 supplies power to each of the actuators in a direction such that the amount of offset is minimized. As shown in FIG. 3, the actuators are driven to accomplish ΔX movement in the direction of the X axis and ΔY movement in the direction of the Y axis, thereby effecting movement of the multilayer optical disc 1 in the direction of the vector OO′. Thereafter, optical disc offset information is acquired again. If the amount of offset does not fall within specified tolerance, the amount of offset of the optical disc is adjusted by readjusting the amount of driving movement of the actuators.

In the first embodiment, four actuators are used for the sake of clarity of operation of the actuators. However, at least three or more actuators may be used for configuration, since any mechanism may be used provided that is the actuators are capable of moving while holding the moving part 302. Although description has been given with regard to the actuators designed to expand and contract in the directions of the X and Y axes, the approach of using actuators capable of moving in any given direction in a two-dimensional plane, such as a plurality of offset stages, may be adopted for configuration. Specifically, the approach involves axially positioning the plurality of offset stages, and rotating each of the offset stages, thereby effecting offset adjustment. Part of the plurality of actuators may be replaced by an elastic material or a spring material. The elastic material absorbs pressing forces of the actuators and thereby relieves stress. This eliminates excessively great forces acting on the moving part 302, and hence enables preventing deformation in the multilayer optical disc 1 incident to warpage of the moving part 302, or the like.

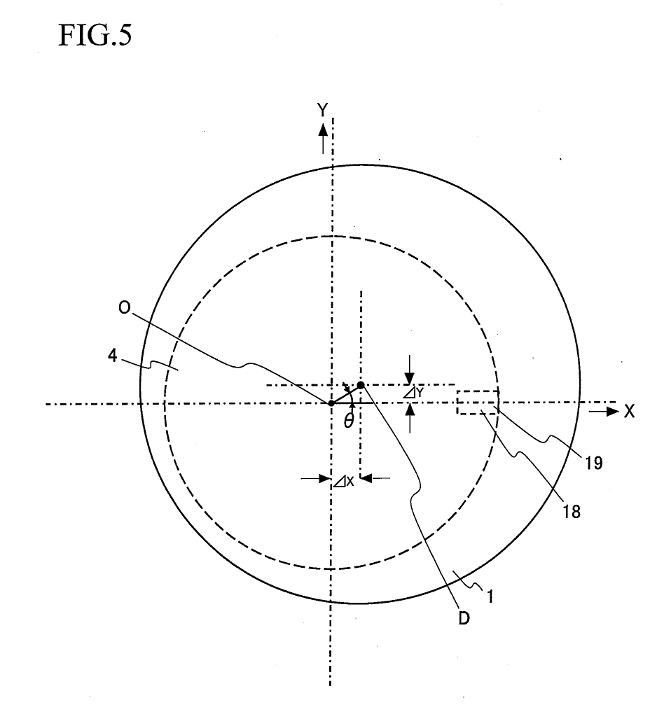

FIG. 4 is a cross-sectional view taken through a disc rotating shaft, of a disc recording and reproducing apparatus according to a second embodiment of the present invention. In FIG. 4, a magnetic sensor 18 such as a Hall device is disposed in the outer periphery of the rotor-side core 503, and a magnetic material 19 such as a permanent magnet is disposed in the outer periphery of the stator-side core 603.

FIG. 5 is a plan view of the multilayer optical disc 1 shown in FIG. 4, as seen from the direction of the rotating shaft 2. The multilayer optical disc 1 is offset ΔX in the direction of the X axis and ΔY in the direction of the Y axis with respect to the hub 4. While the hub 4 makes one rotation, the magnetic sensor 18 moves closer to the magnetic material 19. In FIG. 5, there is shown a situation where the magnetic sensor 18 is located directly above the magnetic material 19.

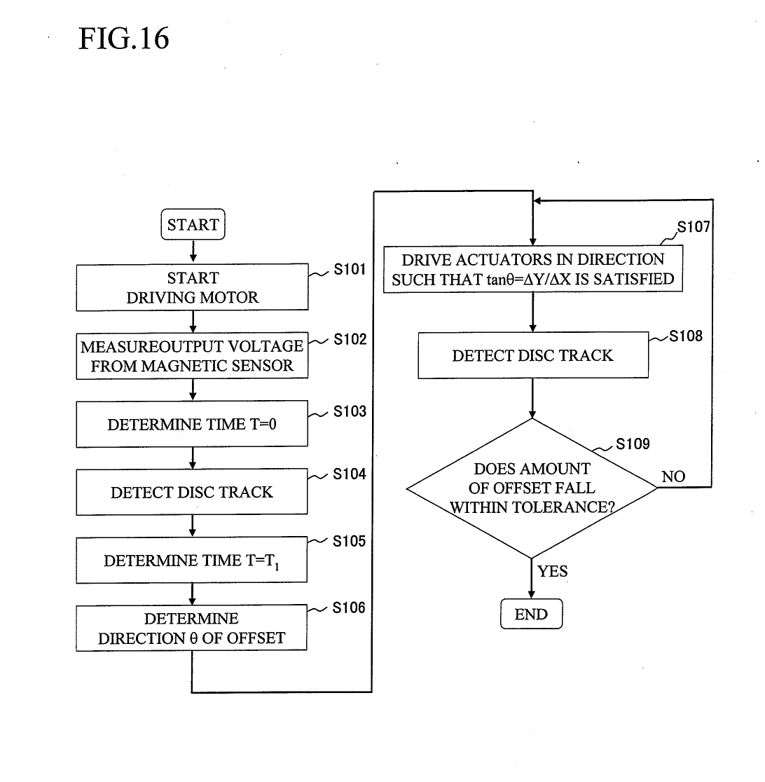

FIG. 16 shows the flow of a procedure for offset adjustment. First, a motor is supplied with power to rotate the hub (step S101). Then, an output voltage from the magnetic sensor 18 is measured (step S102). The instant when the output voltage reaches the peak is the instant when the magnetic material 19 faces the magnetic sensor 18 as shown in FIG. 5. This time is defined as t=0 (step S103).

Then, the optical disc is radiated with a laser, the frequency of crossing of tracks is measured, and the instant of reaching the outermost or innermost circumferential track is measured (step S104). This time is defined as t=t₁ (step S105). A direction θ of offset of the optical disc with respect to the hub 4 is determined from a difference between the times t=0 and t=t₁ (step S106). Then, the actuators 303a, 303b, 303c and 303d are driven as shown in FIG. 3, using a combination of ΔX and ΔY that satisfies an equation tan θ=ΔY/ΔX (step S1107).

Then, the optical disc is radiated with a laser, the frequency of crossing of the tracks is measured again, and the amount of offset is evaluated (step S108). If the amount of offset falls within the tolerance, the procedure is terminated. If the amount of offset does not fall within the tolerance, the actuators are driven again in a direction such that the equation tan θ=ΔY/ΔX is satisfied. This offset adjustment can bring the center D of the disc 1 closer to the center O of rotation of the hub 4.

The above configuration can promptly determine a driving direction of an offset correction unit and hence reduce time for offset correction, as compared to a method for searching for an offset direction by random driving of the offset correction unit and feedback therefrom.

Incidentally, the magnetic sensor 18 and the magnetic material 19 are not necessarily limited to being located as shown in FIG. 4 but may be disposed anywhere, provided that the two are disposed so that one faces the hub 4 that is a rotor, and the other faces the base 8 that is a non-rotor. For example, the magnetic sensor 18 may be disposed on the undermost side of the hub 4, and the magnetic material 19 may be disposed on the surface of the circuit board 9.

The same effect as described above is achieved, also when the magnetic sensor 18 is disposed on the base 8 side and the magnetic material 19 is disposed on the hub 4 side. Further, when a plurality of either or both of the magnetic sensor 18 and the magnetic material 19 are disposed, an angle of rotation of the hub 4 can be detected with higher accuracy. Additionally, a manufacturing process for the optical disc may include recording, on the disc, relative offset information on each recording layer measured for each disc.

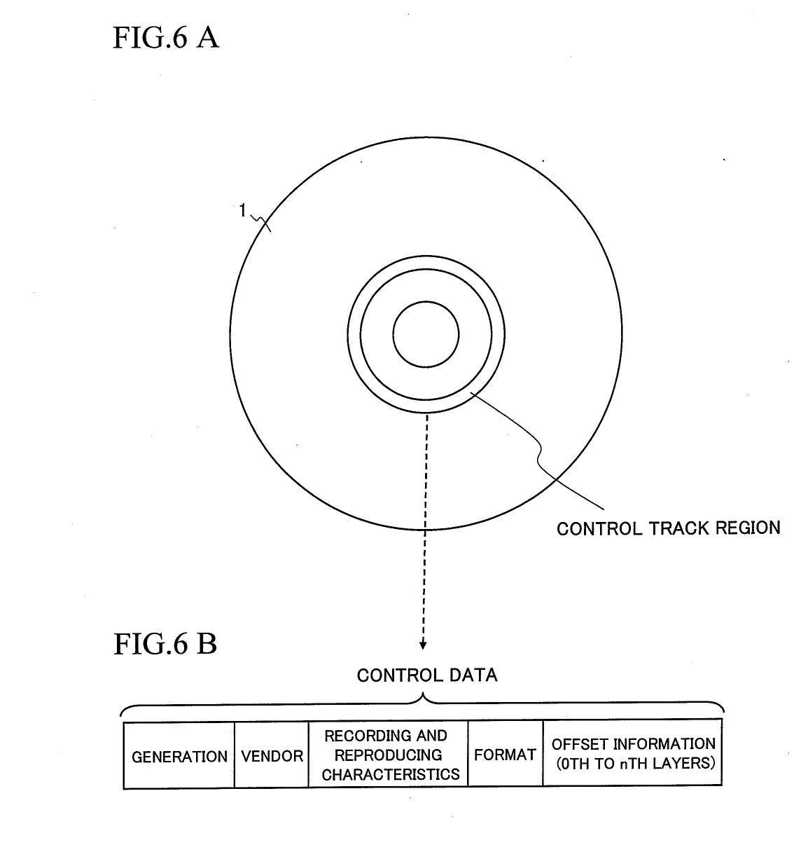

FIGS. 6A and 6B show a recording region for offset information on the multilayer optical disc 1. As shown in FIG. 6A, a control track region having control data recorded therein is formed along the inner circumference of the optical disc. As shown in FIG. 6B, the control data contains, for example, media generation information, media vendor information, disc recording and reproducing characteristic information, format information, and so on. At the last stage of the manufacturing process for the multilayer optical disc, track offset of each of the zeroth to nth layers is measured and recorded as offset information in a given region of the control track region.

As employed herein, the offset information refers to drive information ΔX and ΔY required for the center D of the disc 1 to coincide with the center of the hub 4, or an angle θ and a distance OD, as described for example in connection with FIG. 5.

When the multilayer optical disc is loaded on the recording and reproducing apparatus for the first time, the amount of offset is measured only once by using a laser, and offset correction is performed by the method described in connection with FIGS. 1 to 5. For any other layer, the relative offset information recorded on the disc as shown in FIGS. 6A and 6B can be then used for immediate offset adjustment. This eliminates the need for measuring the amount of offset for each layer, and hence enables reducing the time for offset correction at the time of change from one to another of the layers.

Moreover, the offset information on each recording layer of the optical disc may be recorded on a specified recording layer. When the optical disc is manufactured with high precision so that the specified recording layer alone satisfies a tolerance of an amount of offset, the actuators can perform tracking on the specified layer without the need for offset correction. Since the relative offset information on other layers is recorded on the specified layer, reading this information makes it possible to quickly determine the amount of driving movement of the offset correction unit and hence complete offset correction in a short time. The above configuration eliminates the need for measuring the amount of offset for each layer, and hence enables reducing the time for offset correction at the time of change from one to another of the layers. Moreover, this configuration can reduce manufacturing costs for the multilayer optical disc, since it can loosen the tolerance of the amount of offset of any recording layer other than the specified recording layer.

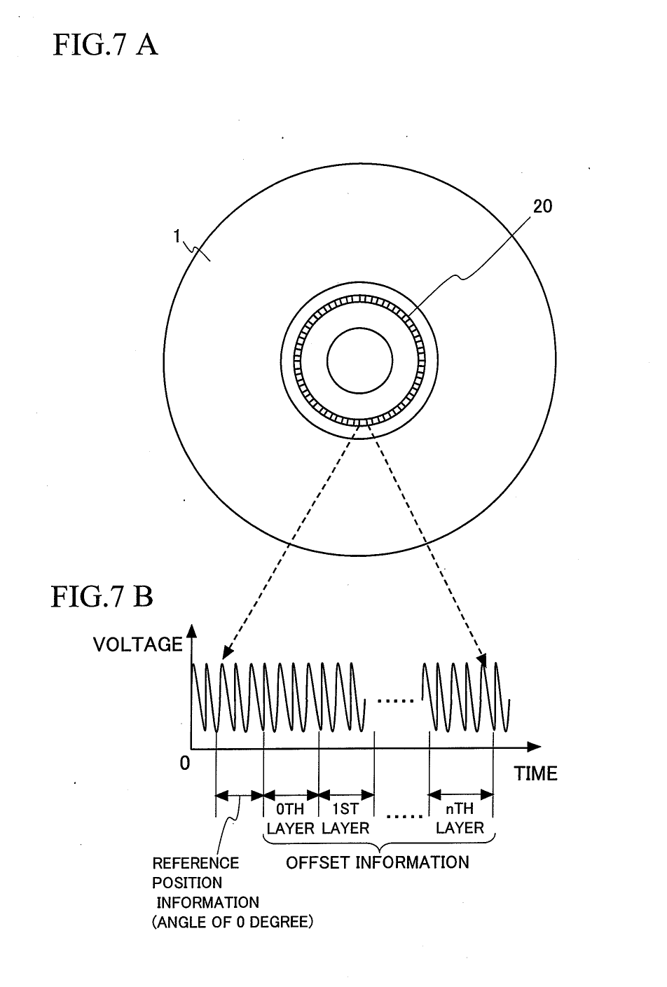

FIGS. 7A and 7B show a burst cutting area and an example of its read signal wave, respectively, of a multilayer optical disc according to a third embodiment of the present invention.

As shown in FIG. 7A, the optical disc 1 is provided with a burst cutting area 20 from which information can be read without the need for disc offset correction. In the manufacturing process for the optical disc, offset information on each recording layer measured for each disc is recorded in the burst cutting area 20. When the optical disc is loaded on the recording and reproducing apparatus for the first time, the optical pickup is driven to move to a position directly under the burst cutting area 20. The burst cutting area 20 is radiated with a laser, and reflected components are detected by the photodetector.

FIG. 7B shows an example of a detected signal. The detected signal contains reference position information indicative of an angle of 0 degree on the disc, and offset information on each of the zeroth to nth layers. This information can be decrypted to determine the amount of driving movement of the offset correction unit. This method can reduce the time for offset correction, as compared to a learning method by random driving of the offset correction unit 3 and feedback therefrom.

The above method may be applied to means other than the burst cutting area. Any means may be used, provided that information can be read therefrom without the need for disc offset correction. For example, information may be recorded in a hole-shaped worked portion such as an embossed dot or a pit, or a groove-shaped worked portion such as a wobble.

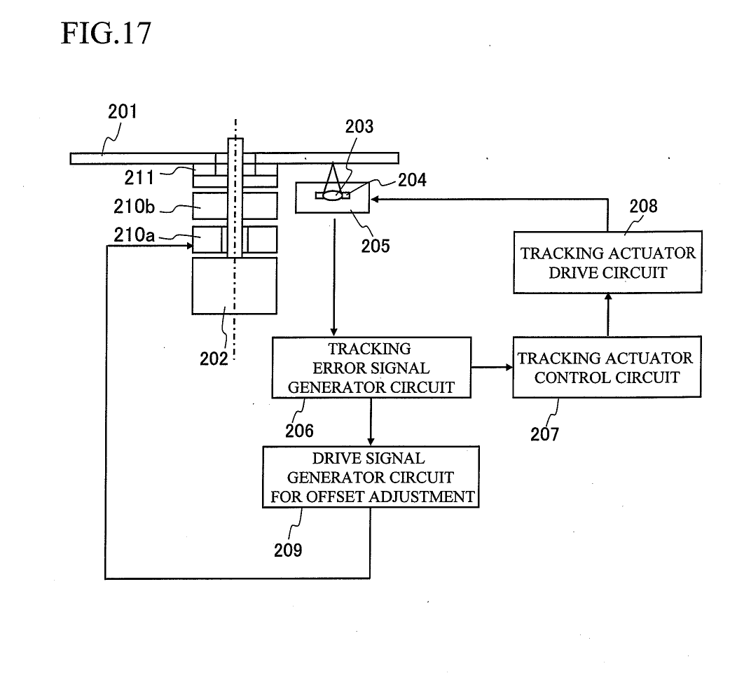

Other than being recorded in the burst cutting area, various worked portions or the like, offset information but may be measured for use at each time of loading of the optical disc. FIG. 17 illustrates, in a block diagram, such a configuration.

In FIG. 17, the circuit 206 generates a tracking-error signal from a signal received by the optical pickup 205. A circuit 209 generates the amounts ΔX and ΔY of driving movement of actuators for offset adjustment, based on an output from the circuit 206. An output from the circuit 209 is fed to a stator-side electromagnetic inductor 210a disposed on the stator side of the motor 202. Information such as ΔX and ΔY is transmitted through electromagnetic induction to a rotor-side electromagnetic inductor 210b, and is used to drive actuators 211 for offset adjustment. Although this configuration has to measure the amount of offset at each time of loading of the optical disc, the configuration eliminates the need for recording offset information in the burst cutting area, various worked portions, or the like and therefore enables offset adjustment without having to change the format of a conventional optical disc.

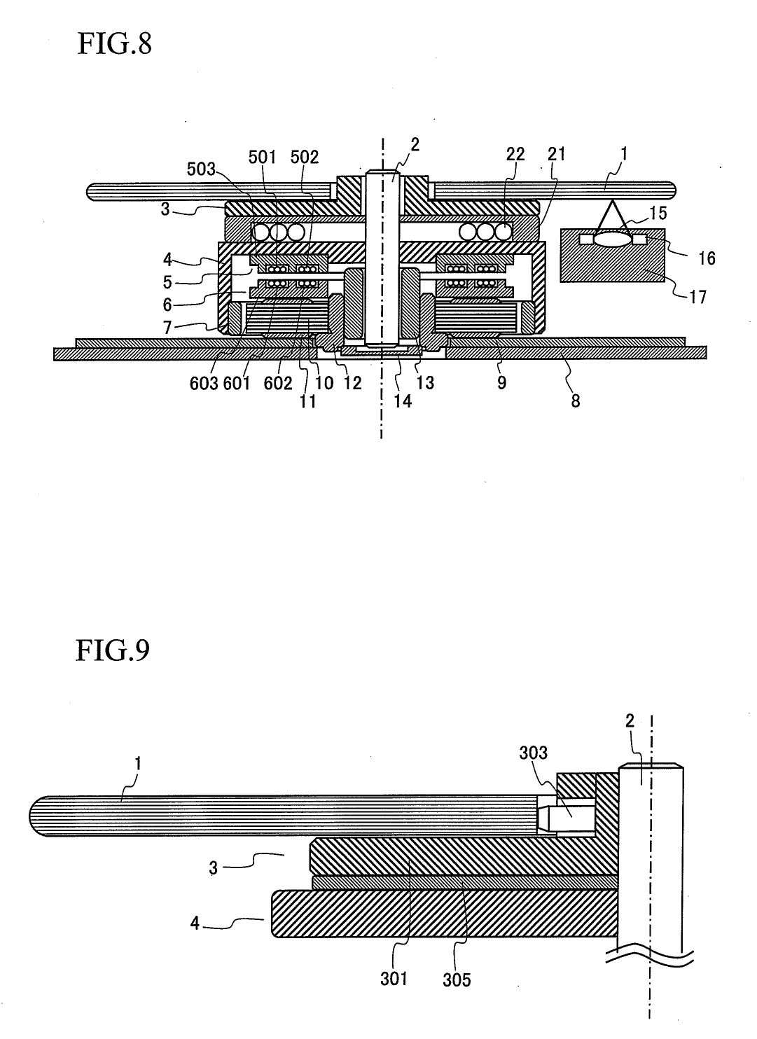

FIG. 8 is a cross-sectional view taken through a disc rotating shaft, of a disc recording and reproducing apparatus according to a fourth embodiment of the present invention.

In FIG. 8, a ball balancer 22 formed of a plurality of balls and a ball holding member 21 are disposed between the disc holder 3 and the hub 4. During rotation of the disc, the ball balancer 22 is relocated by its own centrifugal force to the outer periphery of the ball holding member 21. This action reduces the amount of offset of the offset-corrected disc's center with respect to the center of the rotor, and hence relieves vibrating forces acting on the rotating shaft during rotation of the disc. This is effective in reducing motor power consumption, and improving long-term reliability of a disc unit.

FIG. 9 is a cross-sectional view taken through the disc rotating shaft 2, of the disc holder 3 and its surroundings of a disc recording and reproducing apparatus according to a fifth embodiment of the present invention.

The disc holder 3 is formed of the non-moving part 301, the actuators 303 that press the optical disc 1 at its inner diameter side to fix the disc, and the drive circuit 305 for driving the actuators 303. The actuators 303 are those capable of controlling the amount of expansion and contraction depending on an applied voltage or current, and are configured of electromagnetic actuators, electrostatic actuators, or the like. The amount of expansion and contraction of the actuators 303 is determined by drive power generated by the drive circuit 305, in reference to control information received by the signal receiving coil 502.

At the time of loading of the disc, the loading of the disc is first detected by an optical sensor, a pressure sensor, or the like disposed on the surface of the non-moving part 301. Then, the drive circuit 305 causes the actuators 303 to expand, to thereby fix the optical disc on the hub. At the time of unloading of the disc, upon detection of a request signal for unloading, the drive circuit 305 causes the actuators 303 to contract, to thereby release forces for fixing the optical disc on the hub and thus allow the disc to be unloaded.

This configuration can minimize external forces that cause deformation in the multilayer optical disc 1 and stresses applied to the inner diameter side of the multilayer optical disc 1, as compared to a conventional disc holding mechanism. This makes it possible to provide a highly reliable disc recording and reproducing apparatus.

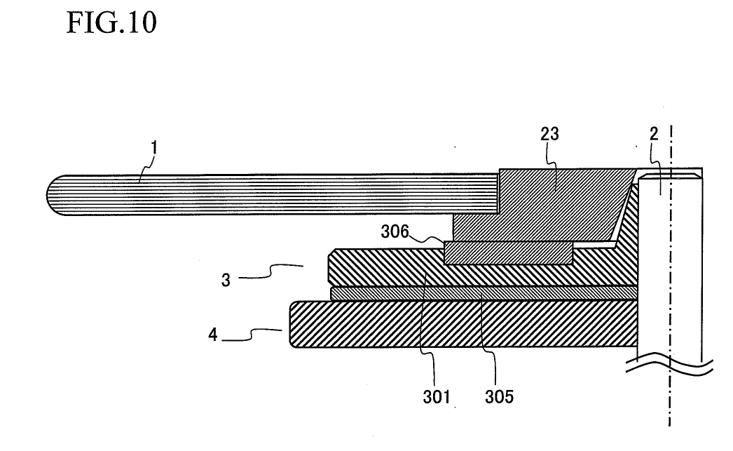

FIG. 10 is a cross-sectional view taken through the disc rotating shaft 2, of the disc holder 3 and its surroundings of a disc recording and reproducing apparatus according to a sixth embodiment of the present invention.

A magnetic material 23 made of a soft magnetic material such as iron is fixedly bonded to the inner diameter side of the optical disc 1. The disc holder 3 is formed of the non-moving part 301, an electromagnetic force generator 306 disposed facing the magnetic material 23, and the drive circuit 305 for driving the electromagnetic force generator 306. The electromagnetic force generator 306 is, for example, an electromagnet formed of a magnetic core and a wire-wound coil. By controlling the amount and direction of an applied current, the electromagnetic force generator 306 can generate forces for attracting or repelling the magnetic material 23.

This configuration can control electromagnetic force applied to the magnetic material 23 at the time of loading or unloading the disc, and can therefore reduce external forces applied to the multilayer optical disc 1, as compared to the conventional disc holding mechanism. This makes it possible to provide a highly reliable disc recording and reproducing apparatus. The above electromagnetic force acts only on the inside of the rotor including the hub 4, and does not act on a contact surface between the shaft and the bearing. This keeps power consumption from increasing during rotation of the disc and also maintains long-term reliability of the bearing, as compared to the approach of generating electromagnetic force between the rotor and the non-rotor.

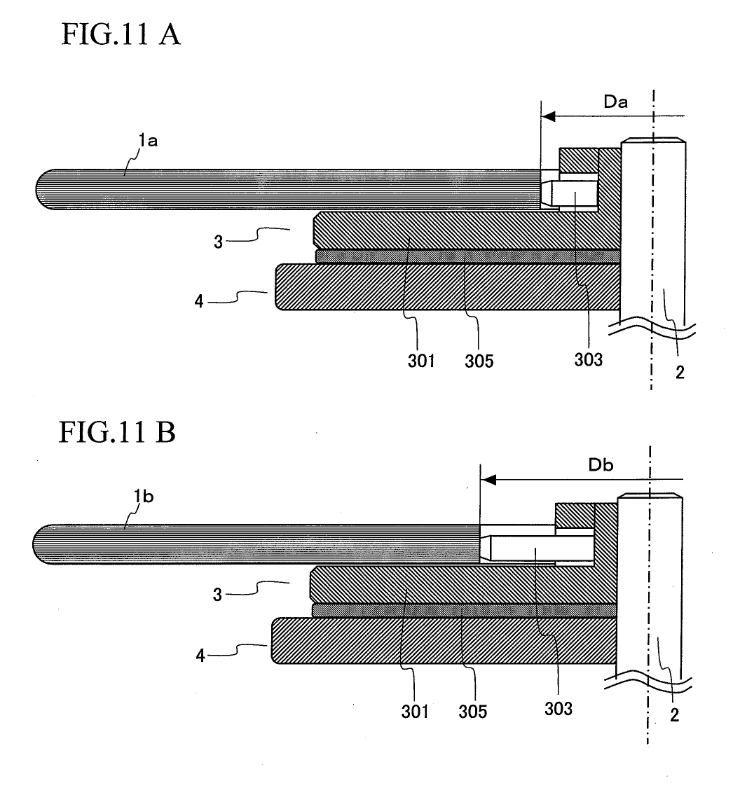

FIGS. 11A and 11B are cross-sectional views taken through the disc rotating shaft 2, of the holder 3 for holding optical discs adapted for different standards for recording densities, and its surroundings of a disc recording and reproducing apparatus according to a seventh embodiment of the present invention.

FIG. 11A is a cross-sectional view of the holder 3 loading a high-standard optical disc 1a with a high recording density. The drive circuit 305 is controlled to adjust the amount of expansion and contraction of the actuators 303 so that they are inscribed in an opening of an inner diameter Da at the center of the optical disc 1a. FIG. 11B is a cross-sectional view of the holder 3 loading a low-standard optical disc 1b with a low recording density. The drive circuit 305 is controlled to adjust the amount of expansion and contraction of the actuators 303 so that they are inscribed in an inner diameter Db of the optical disc 1b.

Power supplied by the electromagnetic inductor can be used to drive the drive circuit 305 and freely adjust the amount of expansion and contraction of the actuators 303. This makes it possible to hold discs of different inner diameters of a plurality of standards as mentioned above. Moreover, the inner diameter of the high-density, high-standard disc is made smaller than the inner diameter of the low-density, low-standard disc. Thus, the smaller inner diameter inhibits the insertion of the high-standard disc into a drive for the low-standard disc, and therefore enables preventing erroneous operation.

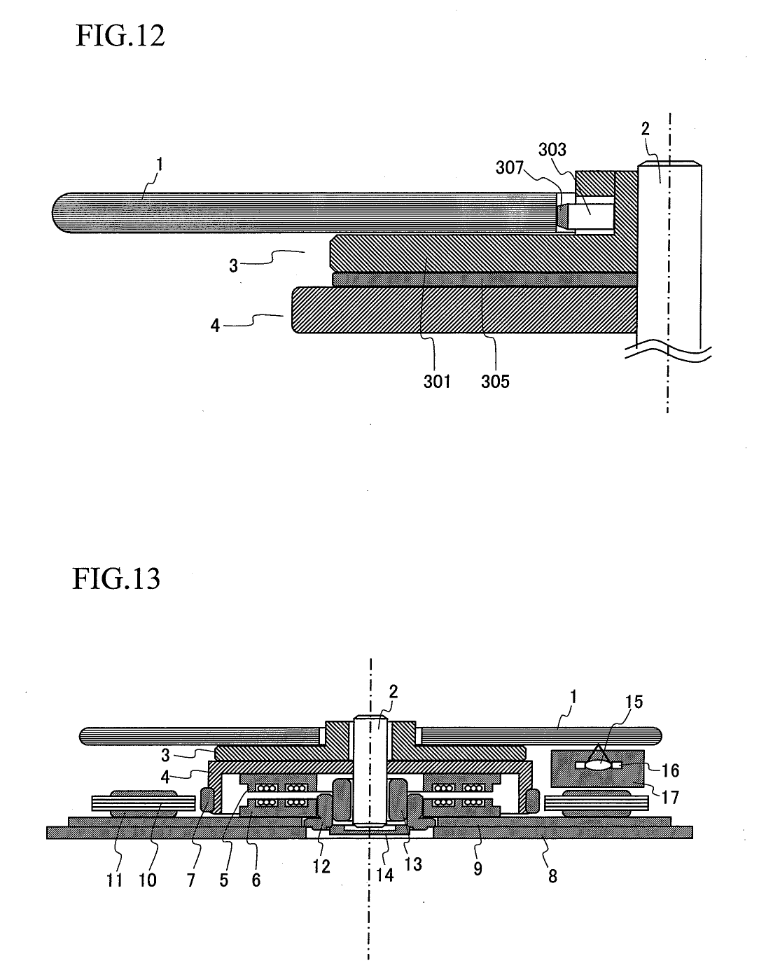

FIG. 12 is a cross-sectional view taken through the disc rotating shaft 2, of the disc holder 3 and its surroundings of a disc recording and reproducing apparatus according to an eighth embodiment of the present invention.

The actuators 303 are provided at their distal ends with pressure sensors 307, respectively, which are electrically connected to the drive circuit 305. The actuators 303 are driven, while monitoring outputs from the pressure sensors 307. The actuators 303 are stopped, at the instant when the outputs from the pressure sensors 307 contacting the inner diameter of the optical disc 1 reach a given threshold value. At this time, the inner diameter of the loaded disc can be evaluated by detecting the traveled distance of the actuators 303. The traveled distance of the actuators 303 can be determined from the value of applied power by preobtaining as data the correlation between the applied power and the traveled distance.

Moreover, the above configuration may obtain the correspondence between inner diameters and recording density standards of the optical disc 1. Thereby, a standard of the loaded disc can be determined by detecting the inner diameter of the loaded disc. This eliminates the need for laser emission or radiation to determine the standard of the disc, thus enabling quicker disc recording and reproduction.

FIG. 13 is a cross-sectional view taken through a disc rotating shaft, of a disc recording and reproducing apparatus according to a ninth embodiment of the present invention.

In the ninth embodiment, a motor unit formed of the stator core 10, the winding 11 and the rotor magnet 7 is disposed in the outer periphery around the rotor-side electromagnetic inductor 5 and the stator-side electromagnetic inductor 6. With the above configuration, the electromagnetic inductors and the motor unit are not stacked on top of each other in the thickness direction of the drive. This configuration makes it possible to achieve a lower-profile disc recording and reproducing apparatus than hitherto. This makes it possible to provide a low-profile disc recording and reproducing apparatus suitable for a notebook computer or the like, as well as solving the problems concerning the multilayer optical disc, of level-to-level offset correction, and the peeling of multilayer films.

The above-described embodiments may be applied to storage devices in general that needs to supply power to the rotor or the disc. These embodiments may be applied to a drive unit for a layer selective type multilayer optical disc using an electro chromic material, as disclosed in Japanese Patent Application Laid-open Publication No. 2004-310912, for example. Further, a plurality of embodiments may be, of course, used in combination. For example, the disc holder according to the fifth embodiment shown in FIG. 9 may be configured to be a disc holder including the offset correction unit according to the first embodiment described with reference to FIGS. 2 and 3, or the disc holder according to the ninth embodiment shown in FIG. 13 may be configured to be a disc holder including the offset correction unit according to the first embodiment described with reference to FIGS. 2 and 3. Alternatively, the disc holder 3 according to the ninth embodiment shown in FIG. 13 may be configured to be a disc holder having the function of the offset correction unit according to the first embodiment described with reference to FIGS. 2 and 3, and also having the function of the disc holder according to the fifth embodiment described with reference to FIG. 9.

What is claimed is:

1. A recording and reproducing apparatus, comprising:
a rotor including a disc holder that holds an optical disc having a plurality of recording layers;
a driver that rotatably drives the rotor around a rotating shaft; and
an optical head that radiates a desired recording layer of the optical disc held by the disc holder, with recording light and/or reproducing light,
wherein the disc holder includes an offset correction unit that corrects the held position of the held optical disc with respect to the rotating shaft.

2. The recording and reproducing apparatus according to claim 1, wherein the disc holder includes a non-moving part fixed to the rotating shaft, a moving part that holds the optical disc and is movable relative to the non-moving part, and an actuator that moves the moving part in relation to the non-moving part.

3. The recording and reproducing apparatus according to claim 2, wherein an electromagnetic inductor for supplying power in a non-contacting manner from a stationary part to the actuator, is disposed between the rotor and the stationary part.

4. The recording and reproducing apparatus according to claim 1, wherein offset information on each of the recording layers is recorded on the optical disc, and the offset information read from the optical disc held by the disc holder is used to control the amount of driving movement of the offset correction unit.

5. The recording and reproducing apparatus according to claim 4, wherein the offset information is recorded in a given recording layer or a burst cutting area of the optical disc.

6. The recording and reproducing apparatus according to claim 4, wherein the rotor is provided with a drive circuit for driving the offset correction unit, and an electromagnetic inductor for supplying power in a non-contacting manner and for transmitting the offset information from the stationary part to the drive circuit, is disposed between the rotor and the stationary part.

7. The recording and reproducing apparatus according to claim 1, wherein the rotor that rotates in conjunction with the disc holder is provided with one of a magnetic sensor and a magnetic material for detecting an angle of rotation of the disc holder, and the stationary part is provided with the other one of a magnetic sensor and a magnetic material.

8. The recording and reproducing apparatus according to claim 1, wherein the rotor includes a ball balancer including a plurality of balls.

9. A recording and reproducing apparatus, comprising:
a rotor including a disc holder that holds an optical disc having a plurality of recording layers;
a disc fixing unit for fixing the optical disc, which is provided in the disc holder;
a driver that rotatably drives the rotor around a rotating shaft;
a drive circuit for driving the disc fixing unit, which is provided in the rotor;
an optical head that radiates a desired recording layer of the optical disc held by the disc holder, with recording light and/or reproducing light; and
an electromagnetic inductor disposed between the rotor and the stationary part, for supplying power in a non-contacting manner from a stationary part to the drive circuit,
wherein the drive circuit drives the disc fixing unit by the power supplied by the electromagnetic inductor.

10. The recording and reproducing apparatus according to claim 9, wherein the disc fixing unit includes a plurality of actuators that press a side surface of an opening formed in the center of the optical disc.

11. The recording and reproducing apparatus according to claim 9, wherein the disc fixing unit includes an electromagnetic force generator that exerts electromagnetic force on a magnetic material disposed in the center of the optical disc.

12. The recording and reproducing apparatus according to claim 10, wherein the actuators are of a plurality of types of lengths for a plurality of types of optical discs having center openings of different diameters depending on recording densities, and the actuator of the disc fixing unit adapted for an optical disc having a large-diameter opening is of a size that does not fit in the opening of the optical disc having a small-diameter opening.

13. The recording and reproducing apparatus according to claim 10, further comprising a unit that evaluates the diameter of the opening of the optical disc held by the disc holder, by measuring a distance traveled by the actuators.

14. The recording and reproducing apparatus according to claim 9, wherein the disc holder includes an offset correction unit that corrects the held position of the held optical disc with respect to the rotating shaft.

15. The recording and reproducing apparatus according to claim 14, wherein the disc holder includes a non-moving part fixed to the rotating shaft, a moving part that holds the optical disc and is movable relative to the non-moving part, and an actuator that moves the moving part in relation to the non-moving part.

16. The recording and reproducing apparatus according to claim 14, wherein offset information on each of the recording layers is recorded on the optical disc, the electromagnetic inductor transmits to the drive circuit in a non-contacting manner the offset information read from the optical disc held by the disc holder, and the drive circuit controls the amount of driving movement of the offset correction unit, in reference to the offset information transmitted through the electromagnetic inductor.

17. A recording and reproducing apparatus, comprising:
a rotor including a disc holder that holds an optical disc having a plurality of recording layers;
a disc fixing unit for fixing the optical disc and/or an offset correction unit provided in the disc holder to correct the held position of the held optical disc with respect to the rotating shaft;
a driver that rotatably drives the rotor around the rotating shaft;
a drive circuit provided in the rotor;
an optical head that radiates a desired recording layer of the optical disc held by the disc holder with recording light and/or reproducing light; and
an electromagnetic inductor disposed between the rotor and the stationary part, for supplying power in a non-contacting manner from a stationary part to the drive circuit,
wherein the rotor is of such a shape as surrounds the electromagnetic inductor,
the driver includes a stator core fixed to the stationary part outside the rotor,
and a rotor magnet fixed in the outer periphery of the rotor, and the drive circuit drives the disc fixing unit and/or the offset correction unit by the power supplied by the electromagnetic inductor.

18. The recording and reproducing apparatus according to claim 17, wherein offset information on each of the recording layers is recorded on the optical disc, the electromagnetic inductor transmits to the drive circuit in a non-contacting manner, the offset information read from the optical disc held by the disc holder, and the drive circuit controls the amount of driving movement of the offset correction unit, in reference to the offset information transmitted through the electromagnetic inductor.

19. The recording and reproducing apparatus according to claim 17, wherein the disc holder includes a non-moving part fixed to the rotating shaft, a moving part that holds the optical disc and is movable relative to the non-moving part, and an actuator that moves the moving part in relation to the non-moving part.

20. The recording and reproducing apparatus according to claim 17, wherein the disc fixing unit includes a plurality of actuators that press a side surface of an opening formed in the center of the optical disc.
